(19) United States
(12) Patent Application Publication
(10) Pub. No.: US 2007/0124762 A1
(43) Pub. Date: May 31, 2007

(54) Selective advertisement display for multimedia content

(75) Inventors: David M. Chickering, Bellevue, WA (US); David E. Heckerman, Bellevue, WA (US); Ying Li, Bellevue, WA (US); Christopher A. Meek, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/291,061

(22) Filed: Nov. 30, 2005

(51) Int. Cl. H04N 5/445; H04N 7/10; H04N 7/025; G06F 13/00; G06F 3/00

(52) U.S. Cl. 725/35; 725/42; 725/34

(57) ABSTRACT

An advertisement display system comprises an analyzer component that analyzes one or more of data associated with at least a portion of a multimedia item, demographic information associated with a user, and contextual data. A presentation component selectively provides at least one advertisement from a plurality of advertisements to a reviewer of the multimedia item based at least in part upon the analysis. The system, for example, can further comprise an ad server, wherein the presentation component receives the at least one advertisement from the ad server based at least in part upon the analysis.

### BACKGROUND

The video entertainment industry generates billions of dollars in revenue each year through, for example, ticket sales to movie theatres, DVD sales, rentals, contracts with television studios, licensing agreements, and the like. Another major source of revenue for television and movie studios is the sale of advertisements. For example, most thirty minute television programs are typically associated with at least three commercial breaks, wherein advertisers purchase time with respect to such programs. If the programs are popular, then price for time to advertise during such program can be quite substantial. This manner of selling advertisements enables owners of video content to generate a significant amount of revenue with respect to such content.

Currently, these advertisements are placed in the midst of a video stream, and provided to each and every user viewing the video regardless of personal interests of the user and/or context associated with the video. For example, an automobile manufacturer may wish to purchase time for advertising their product during one particular television program. Typically, however, the advertisement will have little or nothing to do with content that is displayed during the program. In other words, advertisers may only concern themselves with demographic information describing a type of user that typically watches certain programs or movies, and typically are not concerned with content of the program just prior to or after a commercial break.

Furthermore, the sale of advertisements today for video is confined to conventional televisions, certain portions of movies (e.g., prior to beginning of a movie), and at beginnings of DVDs. However, technology associated with graphical user interfaces upon portable devices has enabled viewing of video content on such portable devices. Furthermore, extended battery life enables these portable devices to display video content for several hours without being forced to recharge or replace the batteries. Thus, a user can watch several television programs or movies on such portable devices without needing to recharge or replace batteries. Today, however, there is no tailored means for providing advertisements on such portable devices. Rather, like conventional televisions, advertising content must be streamed within video content being viewed.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

Described herein are systems and methodologies that facilitate monetizing multimedia content (e.g., audio, video, and/or audio/video content). In other words, advertisers can purchase advertising space associated with particular multimedia content, and such advertisements can be selectively provided to a user. For instance, an actor in a television program may wear an article of clothing that is manufactured by a particular company, and such company may wish to provide additional information relating to the article of clothing in the form of an advertisement to a viewer (e.g., indicating price of the clothing, where the clothing can be purchased, . . . ). Therefore, upon the television program reaching a point where the article of clothing is worn by an actor, an advertisement can be automatically provided to the viewer. For instance, such advertisement can be located in a position upon a viewing screen so as not to substantially obstruct a view of the television program. In another example, the viewer may wish that the television program remain unobstructed with advertisements. Accordingly, an advertisement can be provided only after receiving user input, such as pausing a video, selection of a button on a remote control that indicates a user's interest in an item, etc. Thereafter, one or more advertisements associated with a current position of the video can be provided to the user.

In another example, advertisements can be embedded in a computer-readable edium together with video associated with such advertisements. Thus, a viewer watching a DVD can be selectively provided advertisements based upon a current scene being viewed. For instance, when the viewer pauses the DVD, advertisements relating to such scene can be retrieved from the DVD and displayed to the user. In a specific example, a scene on a DVD can portray several individuals eating pizza, and upon pausing the DVD during such scene advertisements for pizza companies can be displayed. It is to be understood, however, that the other computer-readable mediums can encapsulate the advertising content, such as compact disks, hard-drives, and the like.

In still another example, the multimedia content can be streaming audio and/or video or other broadcast multimedia item received at a computer or television. For instance, the television can be an IP-television, which enables bi-directional communications to occur between a television and a service provider. Based upon content of a video at a particular instance in time, specific advertisements can be retrieved from an advertisement server and displayed to the user. Furthermore, purchases can be made by the user based upon the advertisements. For example, upon pausing a program and/or upon selecting a certain button on a remote control, advertisements associated with a scene currently being viewed can be provided (e.g., for clothing apparel). A viewer can select one or more advertisements to receive more information, and can purchase an item associated with the advertisements as desired. Click-through data can be collected and forwarded to a service for pricing advertising space associated with multimedia content.

Further, advertisements can be selectively provided to an individual based at least in part upon information associated with such user. For example, if it can be determined that a user is within a particular demographic, advertisements can be selectively provided to such user based upon the demographic. For instance, if it is determined (through device ID, user ID, etc.) that a user is within an age demographic relating to senior citizens, advertisements that are associated with such age demographic (e.g., hearing aids, health insurance, . . . ) can be selectively provided upon pausing the program, selecting a button, or other suitable action. As can be discerned, advertisements can be selectively provided with respect to a program based upon any suitable demographic information, including sex, age, and/or location of typical viewers. Moreover, advertisements can be displayed based upon an analysis of multimedia content and demographic information, thereby enabling provision of highly relevant advertisements to viewers.

Advertisements can be displayed to a user based upon more than a current scene. For instance, user identity, IP address, time of day, time of year, metadata associated with the video, device utilized to display the content, and the like can be considered in connection with selecting an advertisement to display. Additionally, the form of an advertisement can change based upon such data. For example, a user employing a small-screen, low-resolution device can have an advertisement displayed differently than an individual watching video on a high-end big-screen television.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a high-level block diagram of a system that facilitates monetizing multimedia content by displaying advertisements that can be associated with the multimedia content.

FIG. 2 is a block diagram of a system that facilitates display of advertisements to a user based at least in part upon viewing position of a multimedia item.

FIG. 3 is a block diagram of a system that facilitates display of advertisements associated with scenes of audio and/or video.

FIG. 4 is a block diagram of a system that facilitates purchase of an item through a displayed advertisement.

FIG. 5 is a block diagram of a system that facilitates downloading advertisement information to a client.

FIG. 6 is a block diagram of a system that facilitates downloading a multimedia item together with advertisements associated therewith.

FIG. 7 is a representative flow diagram illustrating a methodology for selectively providing advertisements to a user.

FIG. 8 is a representative flow diagram illustrating a methodology for providing advertisements to a display device.

FIG. 9 is a representative flow diagram illustrating a methodology for selectively displaying advertisements from a received buy track.

FIG. 10 is a representative flow diagram illustrating a methodology for providing advertisements based upon device analysis and user-related data.

FIG. 11 is an exemplary user interface.

FIG. 12 is an exemplary remote control that can be employed in connection with features described herein.

FIG. 13 is a schematic block diagram illustrating a suitable operating environment.

FIG. 14 is a schematic block diagram of a sample-computing environment.

### DETAILED DESCRIPTION

The subject invention is now described with reference to the drawings, wherein like reference numerals are used to refer to like elements throughout. In the following description, for purposes of explanation, numerous specific details are set forth in order to provide a thorough understanding of the claimed subject matter. It may be evident, however, that such subject matter may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers. The word “exemplary” is used herein to mean serving as an example, instance, or illustration. Any aspect or design described herein as “exemplary” is not necessarily to be construed as preferred or advantageous over other aspects or designs.

Furthermore, aspects of the claimed subject matter may be implemented as a method, apparatus, or article of manufacture using standard programming and/or engineering techniques to produce software, firmware, hardware, or any combination thereof to control a computer to implement various aspects of the subject invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of what is described herein.

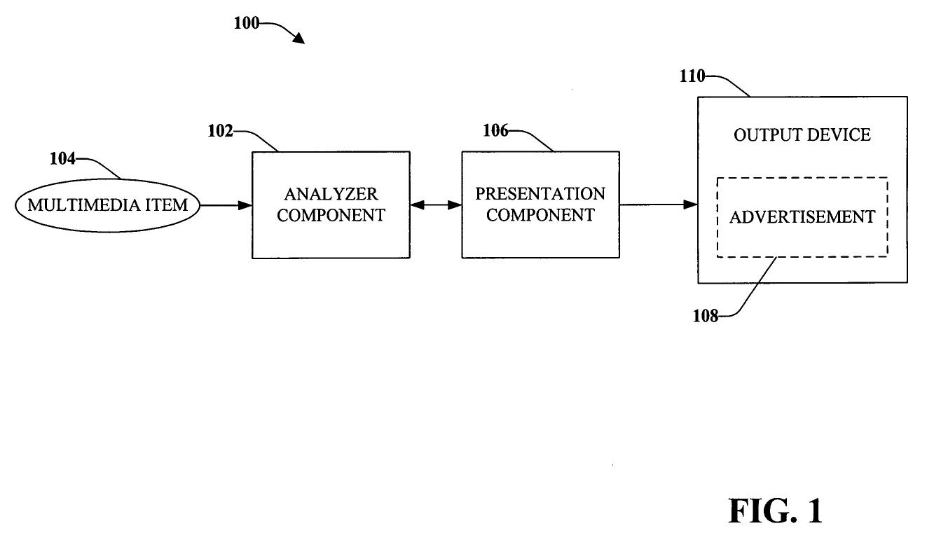

The claimed subject matter will now be described with respect to the drawings, where like numerals represent like elements throughout. Referring now to FIG. 1, an advertisement location and presentation system 100 is illustrated. The system 100 includes an analyzer component 102 that receives a multimedia item 104 (e.g., an audio, video, and/or audio video item) and analyzes at least a portion of such multimedia item 104. In one example, the multimedia item 104 can be created to conform to IPTV, where digital television services are provided to subscribing customers using the Internet Protocol over a broadband connection. This service enables bi-directional communications to occur between a provider and recipient of multimedia. The analysis component 102 can analyze content of the multimedia item 104, current location of the multimedia item 104, device that is being employed to display or output the multimedia item 104, a user that is reviewing the multimedia item 104 (such as demographic information associated with the user), and any other suitable data that may be associated with the multimedia item 104. Furthermore, the multimedia item 104 can be streaming video, video encapsulated in a DVD or other computer-readable medium, or any other suitable multimedia item.

Results of the analysis undertaken by the analyzer component 102 can be provided to a presentation component 106, which can selectively provide an advertisement 108 to a user by way of a output device 110, wherein the output device 110 can be a television, a computer monitor, a graphical user interface on a mobile telephone, a personal digital assistant, a mobile media player, a radio, or any other suitable device. Furthermore, the advertisement 108 can be selected from amongst a plurality of advertisements. In one example, the advertisement 108 can be associated with content of the multimedia item 104 at a particular point in such multimedia item 104. In more detail, at a particular point in time the multimedia item 104 can include several actors or actresses wearing clothing from a particular manufacturer. The analyzer component 102 can make a determination that such clothing is prominent in the multimedia item 104 at a particular point in time, and the presentation component 106 can provide an advertisement for such clothing (e.g., the advertisement 108) to a user through the output device 110. The advertisement 108 can be presented concurrently with the multimedia item 104 in such a manner that content of the multimedia item 104 is not substantially obstructed and/or can be presented upon receiving user input, such as pausing the multimedia item 104 or depressing a “buy” button (or similar button).

In another example, the advertisement 108 can be provided to a user based at least in part upon demographic information associated with the user. For instance, if the reviewer of the multimedia item 104 is determined to lie within a male demographic between ages 15-20, the advertisement 108 can be selectively provided based upon such demographic information. Therefore, the presentation component 106 can tailor advertisements based at least in part upon individual user demographics. Further, the system 100 can be updated as user demographic alters (e.g., if the user moves, as the user ages, change in user device). The presentation component 106 can receive most recent demographic information and selectively provide the advertisement 108 based at least in part thereon. Still further, the advertisement 108 can be provided based solely upon contextual information, such as location of a user, time of day, and/or other suitable contextual data.

The presentation component 106 can select the advertisements, for example, from a computer-readable medium associated with the multimedia item 104. For instance, a DVD can be packaged with the multimedia item 104 as well as advertisements associated with content of the multimedia item 104. Thus, during particular scenes, if the user pauses the multimedia item 104, then advertising content can be retrieved from the DVD and presented to the user through the output device 110. In another example, the presentation component 106 can access a server through a broadband connection and receive the advertisement 108 from such server. In more detail, the analyzer component 102 can determine that the multimedia item 104 is associated with one particular scene, and can relay such information to the presentation component 106. The presentation component 106 can then access the server with such information and retrieve an advertisement relating to the scene. Furthermore, the server can include advertisements that are tailored for particular display devices and/or particular users.

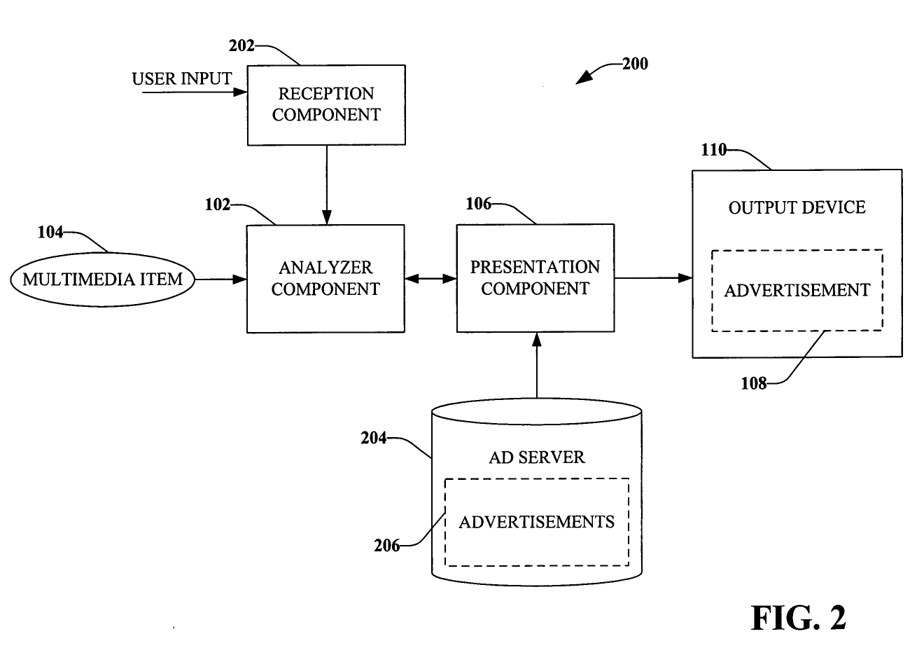

Now referring to FIG. 2, an advertisement presentation system 200 is illustrated. The system 200 includes a reception component 202 that receives user input with respect to the multimedia item 104. For example, a user can pause the multimedia item 104 through depressing a button upon a remote control, a portable phone, through voice commands, etc. Similarly, the reception component 202 can receive input relating to a user's desire to purchase an item associated with a screen through selection of a “buy” button or other suitable button. Additionally, the reception component 202 can receive an indication that a user wishes to traverse through disparate scenes associated with the multimedia item 104 and be provided advertisements associated with such scenes. Still further, the reception component 202 can determine a type of device employed by a user through the user input, contextual information associated with the user input (e.g., time of day, user history, user context, IP address associated with a device, . . . ), etc. Upon receiving the user input from the reception component 202, the analyzer component 102 can analyze the multimedia item 104 to determine content of the multimedia item 104 at particular locations associated with the user input and/or analyze demographic information associated with the user. For instance, given a location of the multimedia item 104, an advertisement associated with such portion can be determined.

The presentation component 106 can retrieve or request the advertisement from an ad server 204, which can include a plurality of advertisements 206 associated with several multimedia items (e.g., audio, video, and/or audio/video items). Thus, the presentation component 106 can provide the ad server 204 with an identity of the multimedia item 104, scene of the multimedia item 104 at the time user input was received, content of the user input, demographic information associated with the user, device type that is being employed to review the multimedia item 104, and/or contextual data associated with the user. Based upon such information, the presentation component 106 can receive an advertisement from the plurality of advertisements 206 that can relate to content of the multimedia item 104 and/or to a particular demographic (in contrast to simply being streamed in with a video regardless of content of the video). The selected advertisement 108 can be presented to a user on the output device 110.

The system 200 enables prospective advertisers to associate advertisements with content of the multimedia item 104 and/or individual users based upon demographic information relating to the user. For example, an advertiser can purchase advertising space with respect to a particular scene within the multimedia item 104, and have such advertisement presented to a user through the output device 110 automatically as the multimedia item 104 is played and/or upon receipt of the user input. In a specific example, a scene in the multimedia item 104 may include several actors and actresses dining on pizza. A pizza company can purchase advertisement time/space associated with such scene, and upon a user pausing the multimedia item 104 or selecting a “buy” button (or the like), the analyzer component 102 can pass scene identity (location) of the multimedia item 104 to the presentation component 106, which can in turn receive the pizza company's advertisement and provide it to the user by way of the output device 110. Accordingly, the system 200 provides for association between multimedia content and advertisements.

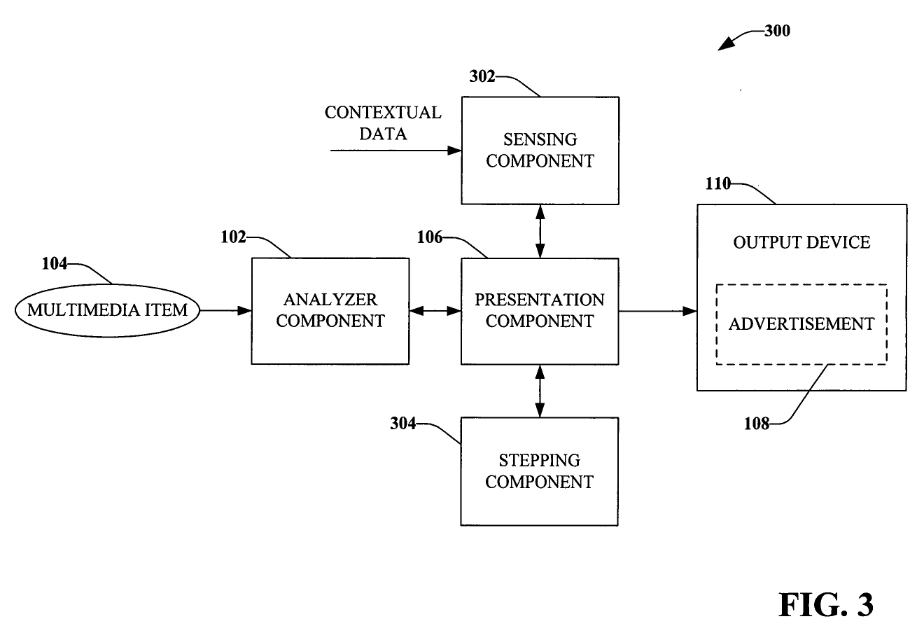

Turning now to FIG. 3, a system 300 that facilitates provision of advertisements to a user based at least in part upon current scene associated with a multimedia item (e.g., audio, video, and/or audio/video), demographic information associated with the multimedia item, and/or contextual data is illustrated. The system 300 includes the analyzer component 102, wherein such analyzer component 102 analyzes the multimedia item 104 as it is being played and/or prior to the multimedia item 104 being played. Additionally or alternatively, the analyzer component 102 can receive and analyze demographic information associated with the user. In a specific example, the analyzer component 102 can be employed to determine a scene of the multimedia item 104 being reviewed when user input is received (e.g., a pause command). The system 300 further includes a sensing component 302 that senses contextual data associated with an individual reviewing the multimedia item 104 and/or being provided the multimedia item 104. For example, the sensing component 302 can detect physical location of a user that is reviewing the multimedia item 104, time of day, time of year, device being employed to review the multimedia 104, and any other suitable contextual data.

The sensed contextual data ascertained by the sensing component 302 can be provided to the presentation component 106 together with a current scene determined by the analyzer component 102. The presentation component 106 can then provide the advertisement 108 to the output device 110, where the advertisement 108 is selected based at least in part upon the sensed contextual data and a scene of the multimedia item 104 provided by the analyzer component 102. Use of the contextual data can cause the presentation component 106 to provide disparate advertisements to a user for different reviews of the multimedia item 104. For example, in one review, the sensing component 302 can determine that it is near lunch time and that the user is at their place of residence. Based upon this determination, the advertisement 108 provided to the output device 110 by the presentation component 106 can be related to a food product that can be delivered to the user. In another review, the sensing component 302 may determine that the multimedia item 104 is being reviewed during evening hours, and the advertisement 108 provided to the output device 110 by the presentation component 106 may relate to home security systems.

The system 300 can further include a stepping component 304 that allows a user to step through scenes of the multimedia item 104 and review advertisements associated with such scenes. For example, a particular scene may include a particular furniture line, a food product, clothing, and various other items, while another scene may depict jewelry and an automobile. The user can employ the stepping component 304 to view all advertisements associated with the first scene and thereafter view all advertisements associated with the second scene. The advertisements can provide information to the user such as name of a product, where the product can be purchased, and/or can provide an option to purchase the item through the output device 110.

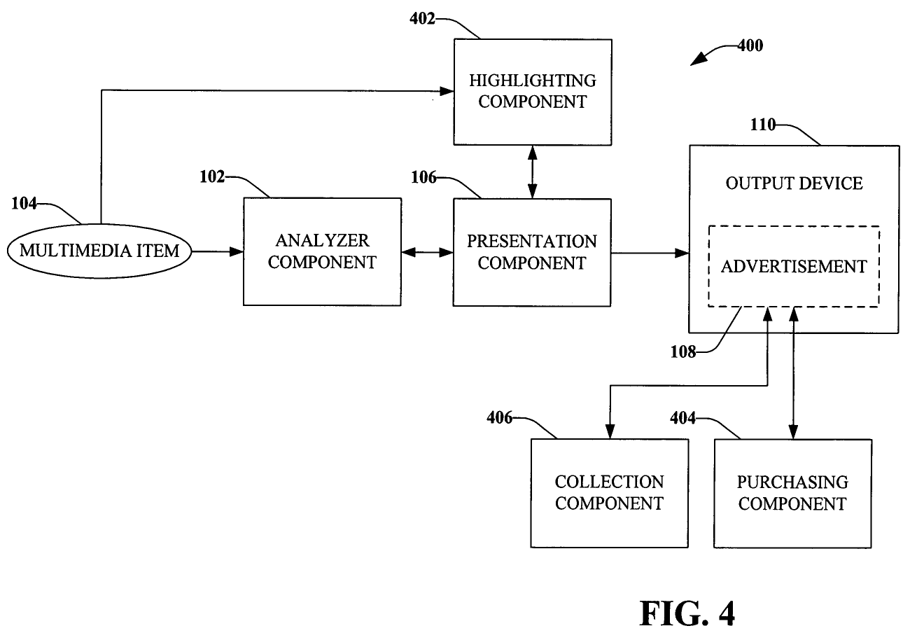

Now referring to FIG. 4, an advertisement presentation system 400 is illustrated. The system 400 includes the analyzer component 102 that receives and analyzes the multimedia item 104, such that the presentation component 106 can be provided with information about a particular scene of the multimedia item 104. The presentation component 106 can then be employed to provide the advertisement 108 to the output device 110 based at least in part upon the information (e.g., current scene) provided by the analyzer component 102. The system 400 can further include a highlighting component 402 that facilitates rendering content of the multimedia item 104 selectable by a user, wherein selection of the content causes an advertisement associated with such content to be output. For instance, an automobile within the multimedia item 104 can be highlighted through data manipulation or data overlay undertaken by the highlighting component 402, wherein the content is selectable through clicking of a mouse, voice commands, a remote control keypad, and the like. In other words, selectable content can act as a hyperlink within the multimedia item 104. Pursuant to one example, content may only be highlighted when hovered over by a pointing mechanism, thereby leaving the multimedia item 104 unobstructed. In another instance, the content may be lightly highlighted when a pointing mechanism is hovered over a display region, and then more prominently highlighted when hovered over particular content. The highlighting component 402 can cause video hyperlinks data to be broadcast as a stream within the multimedia item 104 and synchronized at the output device 110 with content of the multimedia item 104.

The highlighting component 402 can provide, for example, a rectangle or other suitable shape that tracks particular content, wherein such shape may be applied to two key frames (across, for instance, hundreds of frames) for the beginning and ending of appearance of the content. The highlighting component 402 can then employ a tracking algorithm that can track the content even when the content is ambiguous or there are severe occlusions. If the content is obstructed by other content, the algorithm can infer the trajectory of the content based upon past movement or location of the content at the second key frame. Text can also be provided upon hover so as to provide additional information to the user regarding the content that is selectable. If the selectable content (rendered by the highlighting component 402) is selected, then an address associated therewith can be employed to provide the user with the advertisement 108 (wherein such advertisement is related to the selected content).

The system 400 can further include a purchasing component 404 that facilitates user purchase of an item through the advertisement 108 provided on the output device 110. For example, the purchasing component 404 can accept and authorize payment information, such as with respect to a credit card or debit card. Furthermore, the purchasing component 404 can be associated with a shipping engine, wherein a user can provide information relating to where the item is to be shipped. The system 400 can also include a collection component 406 that collects and/or calculates data relating to selection of the advertisement 108 and other advertisements provided to the output device 110 by the presentation component 106. This data can be, for example, click-through rates associated with the advertisements 108, impressions associated with particular advertisements, number of purchases related to the advertisements, and other suitable data. This collection component 406 can thereafter relay this data to the presentation component 106, which can provide advertisements to the output device 110 based at least in part upon such data. Furthermore, the click-through data and other related data can be employed in connection with determining prices for certain advertisements and/or portions of the multimedia item 104. In other words, portions of the multimedia item 104 that are associated with a greater number of clicks or requests to view advertisements may be associated with a higher advertising price than other portions of the multimedia item 104. Thus, the collection component 406 can report click-through data to an advertisement server.

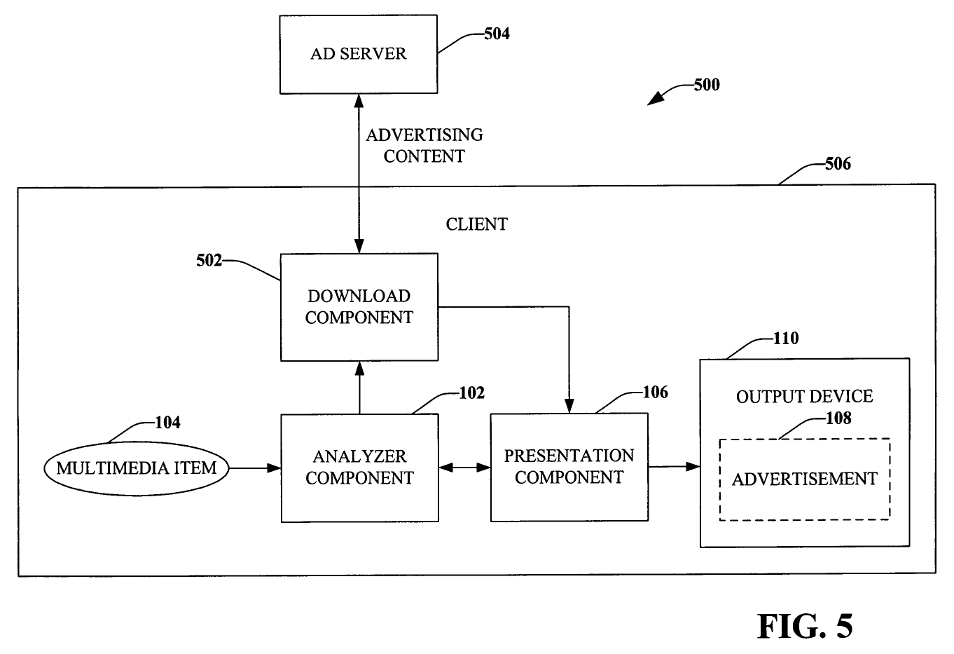

Now referring to FIG. 5, a system 500 for providing users with advertisements based upon content of multimedia (audio, video, and/or audio/video) and/or demographic information related to specific users is illustrated. The system 500 includes the analyzer component 102, which receives and analyzes the multimedia item 104, receives and analyzes demographic information associated with a user or set of users, and/or receives and analyzes contextual data. For instance, the analyzer component 102 can determine an identity of the multimedia item 104. In a more specific example, the multimedia item 104 can be read from a DVD, and the analyzer component 102 can determine title or content of such DVD. Similarly, the multimedia item 104 can be stored on a hard drive or within some other computer-readable medium, and the analyzer component 102 can determine title of the multimedia item 104. Further, demographic information relating to a user or users can be received from a networked data store. This determined information can be provided to a download component 502, which creates a connection to an ad server 504 over a broadband connection. In one example, the ad server 504 can be connected to the download component 502 by way of the Internet. The download component 502 can then proceed to receive advertising content from the ad server 504 that is to be associated with the multimedia item 104.

The presentation component 106 can operate as described above, wherein the advertisement 108 is presented based at least in part upon an analysis of the multimedia item 104 undertaken by the analyzer component 102 and/or demographic information associated with a particular user. The download component 502, the analyzer component 102, the presentation component 106, and the output device can all be located within a client 506, thereby enabling seamless review of the multimedia item 104 and advertisement without connection delays or delays caused by lack of bandwidth. The advertising content received from the ad server 504 at the download component 502 can be unchanged with contextual conditions or can alter based upon context. If the advertising content is to alter given disparate contexts, the download component 502 can make inferences regarding which advertisements to associated with the multimedia item 104 given user identity, identity of the client, user context, time of day, and various other contextual information.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action. In a specific example, trends associated with user buying habits can be detected and provided to the download component 502, which can then analyze such data and infer advertising content to request from the ad server 504. In another example, the ad server 504 can utilize contextual data to make inferences and provide advertising content to the download component 502 based upon contextual data.

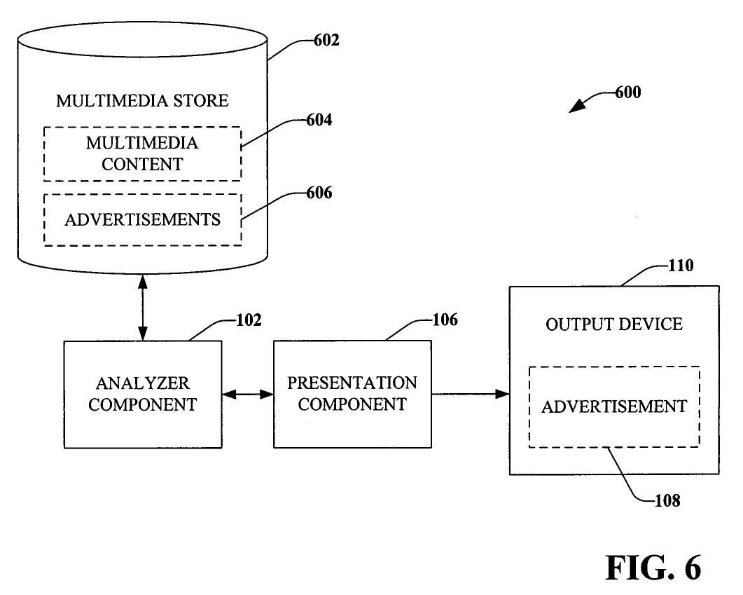

Turning now to FIG. 6, a system 600 that facilitates provision of advertisements to a user based upon multimedia item content, contextual data, and/or demographic information associated with a particular user is illustrated. The system 600 includes the analyzer component 102, which is communicatively coupled to a multimedia store 602. For instance, the analyzer component 102 can be associated with a television, computer, or any other suitable presentation device, and the multimedia store 602 can be associated with a content provider, such as a cable company, a satellite television company, or other such provider. Thus, the multimedia store 602 can include one or more multimedia items 604, demographic information associated with particular users, as well as advertisements associated with the stored multimedia items. In one example, the multimedia store 602 can be associated with an on-demand video service, wherein video is provided to a user by way of a network at the user's convenience. Thus, upon request of a multimedia item from the multimedia store 604, advertisements associated therewith can be provided to the user with the requested video.

When the user reviews the multimedia item, the analyzer component 102 can analyze content, such as current scene, and provide such analysis to the presentation component 106. Similarly, the analyzer component 102 can analyze the demographic information associated with a user and/or contextual data. While the multimedia item is being reviewed and/or upon receiving user input, the presentation component 106 can selectively provide the advertisement 108 (that is associated with a particular scene and/or demographic) to a user through the output device 110. In one example, disparate fees can be provided for different modes of viewing video. For instance, a first, lesser charge may be associated with video if advertisements are provided on a display region while the video is being viewed. A second, greater expense may be associated with video if the user only wishes to be provided advertisements after user action (e.g., pausing the video). The system 600 thus provides novel means for generating revenue (through sale of advertisements associated with content) with respect to multimedia.

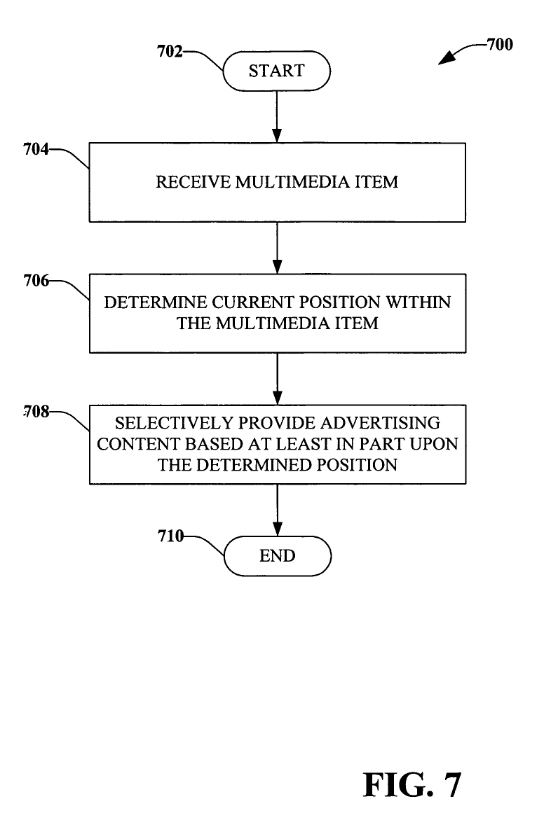

Referring now to FIGS. 7-10, methodologies in accordance with the claimed subject matter will now be described by way of a series of acts. It is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring specifically to FIG. 7, a methodology 700 that can be employed in connection with monetizing multimedia content is illustrated. The methodology 700 begins at 702, and at 704 a multimedia item is received. The multimedia item can be received through reading a removable disk, such as a DVD. In another example, the received multimedia item can be streaming video received over a network. Further, the received multimedia item can exist on a hard drive or in memory. Thus, the multimedia item can be received in any suitable manner. At 706, while the multimedia item is being reviewed, a current position within the multimedia item is determined. For instance, the determined position can relate to a time from the beginning of the multimedia item, time from end of the multimedia item, a particular scene within the multimedia item, and the like, and can be determined in any suitable manner. At 708, advertising content is selectively provided based at least in part upon the determined position, demographic information associated with a particular user, and/or contextual data. For example, an advertiser may wish to have their advertisement associated with a particular portion of video (e.g., when items associated with the advertiser are displayed within the video). Thus, the advertiser can purchase advertising time/space associated with one or more portions of the video. When the video is viewed by a user and the user provides an action (e.g., pausing, selecting content on a display region, . . . ), the advertisement associated with the determined position can be displayed to the user. The methodology then completes at 710.

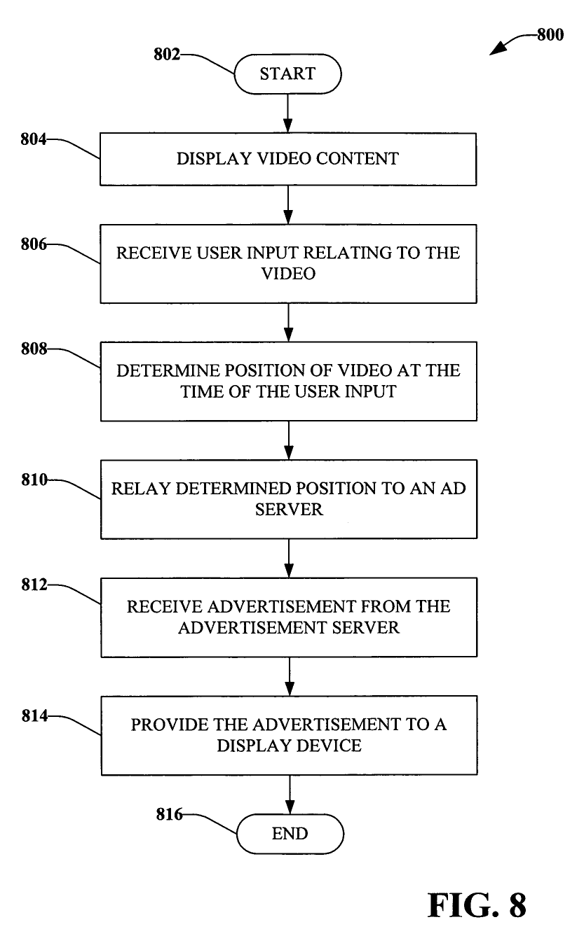

Now turning to FIG. 8, a methodology 800 for providing advertisements to a display region is illustrated. The methodology 800 begins at 802, and at 804 video content is displayed. For example, the video content can be displayed on a television, a computer, a portable device, or any other suitable device. At 806, user input relating to the video is received while the video content is being displayed. For instance, the user input can be selection of a hyper-linked video object, pausing of the video, selection of a “buy” button (or other suitable button), or other suitable user input.

At 808, a location of the video at the time of receipt of user input is determined. The location can relate to a particular scene, a series of scenes, a time from beginning of the video, and the like. At 810, the determined location is relayed to an ad server over a network connection, which can be wireless, wirelined, or a combination thereof. The ad server can include advertisements associated with various videos, wherein the advertisements may vary depending upon sensed context. At 812, at least one advertisement is received from the advertisement server, wherein the advertisement is selected based at least in part upon the determined location at 808. At 814, the received advertisement is provided to the device employed to display the video content. Thus, it can be discerned that advertisements in the ad server can be updated over time; therefore, advertisements associated with a first viewing of the video may differ from advertisements associated with a second viewing of the video. The methodology 800 then completes at 816.

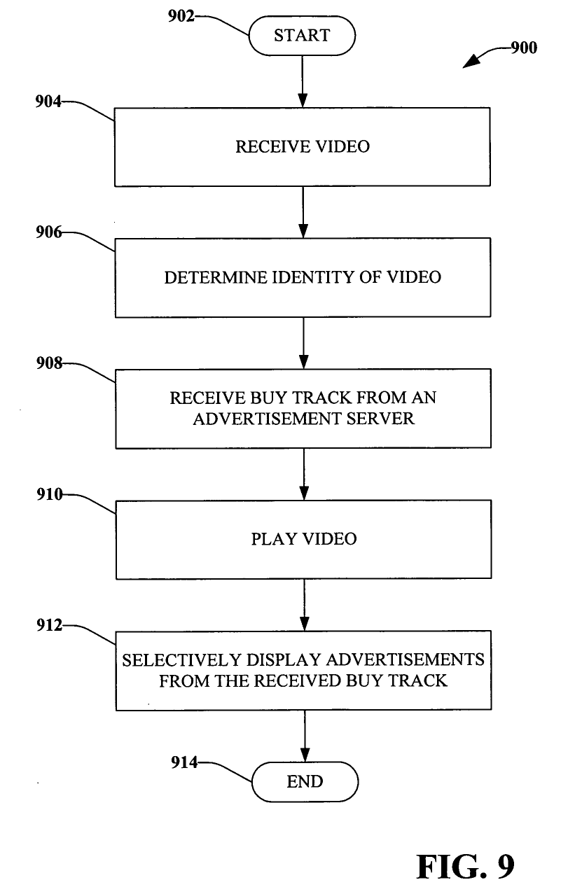

Referring now to FIG. 9, a methodology 900 for selectively displaying advertisements to a user is illustrated. The methodology 900 initiates at 902, and at 904 video is received. At 906, identity of the video is determined. For example, if a DVD is played, title and content of the DVD can be determined to identify the video of video content within the DVD. At 908, a buy track specific to the video is received, thereby placing advertisements associated with the video at the device used to display the video. At 910, the video is played, for example, through an application designed for media play, through hardware that is utilized for playing DVDs, or any other suitable player. At 912, advertisements are selectively displayed from the received buy track. For instance, when a user viewing the video pauses the video, advertisements that relate to such position can be retrieved from the buy track and provided to the user. The methodology 900 then completes at 914.

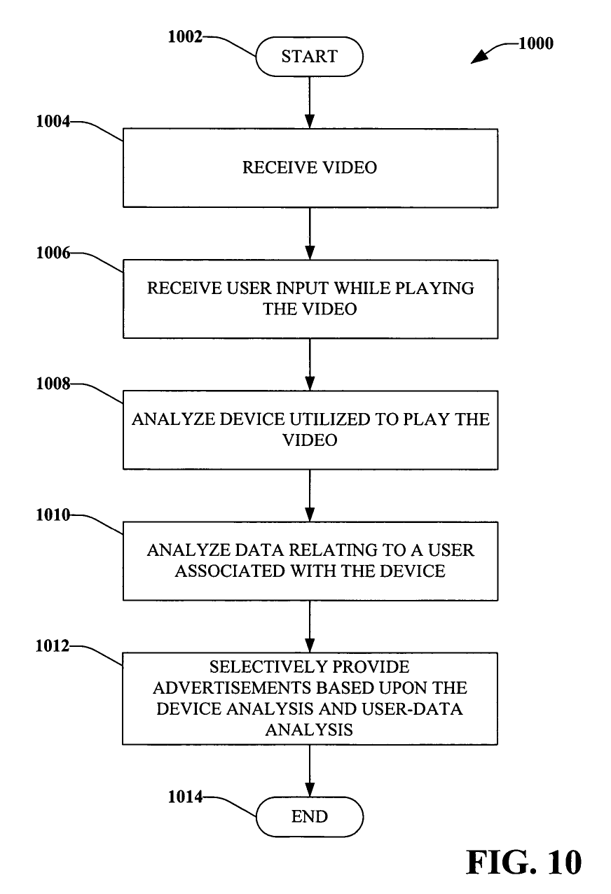

Now turning to FIG. 10, a methodology 1000 for providing advertisements with respect to video content is illustrated. The methodology starts at 1002, and at 1004 video is received. At 1006, user input is received while the video is playing, such as a command to pause the video or to review advertisements associated with at least a portion of the video. At 1008, a device utilized to play the video is analyzed. For example, the analysis can be through an active querying of the device to determine device identity and device parameters, wherein the query can initiate from an advertisement server. At 1010, data relating to a user associated with the device is analyzed. Such data can include previous advertisements reviewed by the user, geographic location of the user, time of day, time of year, day of week, and the like. At 1012, advertisements are selectively provided during the video and/or upon receipt of user input during play of the video based at least in part upon the device analysis and the user-data analysis. For instance, a certain advertisement may not be desirable to display on a graphical user interface of a portable device—therefore, a disparate advertisement can be selected. Further, if it can be determined that a user has reviewed a particular advertisement several times, it may be desirable to provide such user with a disparate advertisement. The methodology 1000 then completes at 1014.

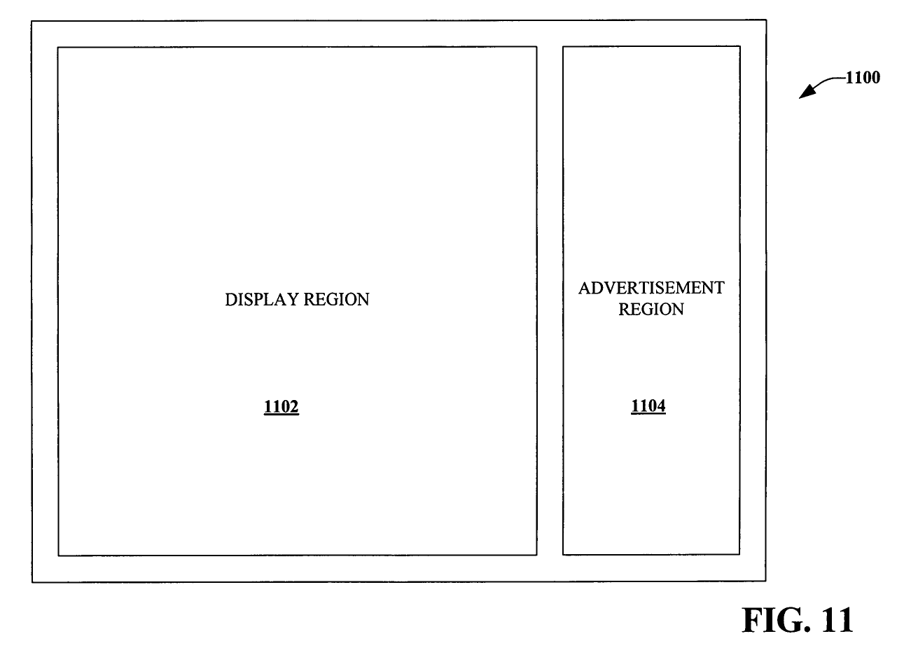

Turning now to FIG. 11, a representative depiction of a graphical user interface 1100 that can be employed in connection with features described herein is illustrated. The graphical user interface 1100 can include a display region 1102 in which video content is rendered. The interface 1100 can further include an advertisement region 1104 that can display advertisements while video is being presented in the display region 1102. In a disparate embodiment, the advertisement region 1104 may only be displayed upon receipt of user input. For example, when a user pauses video displayed in the display region 1102, the advertisement region 1104 can be created, and advertisements relating to content associated with the video at the time of receipt of the user input can be provided in the advertisement region 1104. In still another example, the display region 1102 can include hyper-linked video objects, and upon hovering over such objects information relating to the objects can be displayed in the advertisement region 1104. If the hyper-linked video object is selected, an advertisement for the selected content can be rendered in the advertisement region. Given these examples, it can be discerned that any suitable manner of displaying video and advertisements associated therewith are contemplated and intended to fall under the scope of the hereto-appended claims.

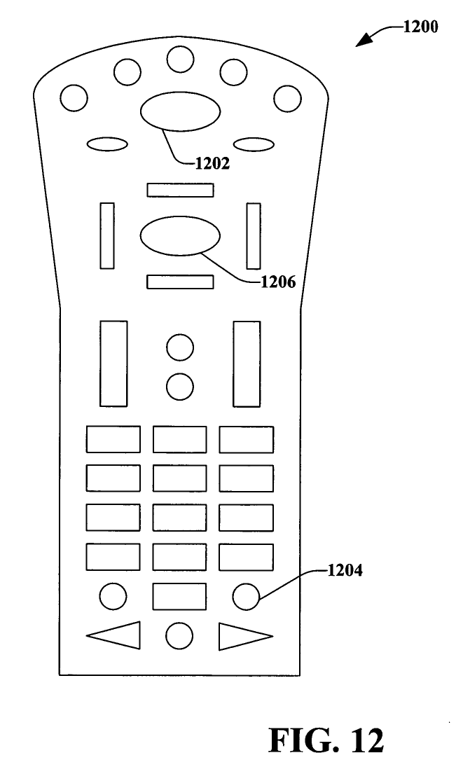

Now referring to FIG. 12, an exemplary remote control 1200 that can be employed to provide user input in accordance with various features described herein is illustrated. The remote control 1200 can include a button 1202 that causes a display device to be powered on or turned off. Furthermore, the remote control 1200 can include a pause button 1204 that may be depressed by a user, thereby causing video content displayed on the device to be paused. Upon pausing the video, advertisements associated with content of the video at the time of pausing can be provided to a user. In another example, the remote control 1200 can include a “buy”button 1206, wherein depressing of such button 1206 causes advertisements associated with a current position of video to be displayed. Furthermore, the “buy”button can be employed to effectuate purchase of one or more items that are displayed on advertisements provided to the user. The remote control 1200 further includes various other buttons associated with conventional remote controls, such as a numerical keypad, a stop button, a menu button and the like. Accordingly, user input that causes advertisements to be displayed is not limited solely to pausing video or depressing the “buy” button 1206, but can alter depending upon desired implementation. Furthermore, devices with keypads already associated therewith may not be associated with a remote control and/or may not need to receive input from a remote control in order to receive user input. For example, mobile devices include pressure sensitive screens and/or keypads, and the user input can be received through such screens and/or keypads. Similarly, computers include keypads, wherein users can provide sufficient input through suck keypads.

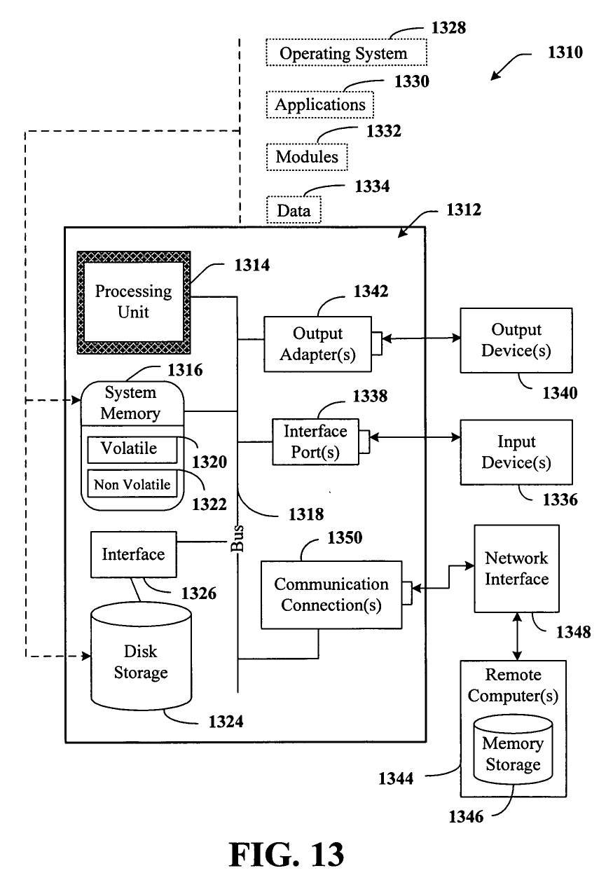

In order to provide additional context for various aspects of the subject invention, FIG. 13 and the following discussion are intended to provide a brief, general description of a suitable operating environment 1310 in which various aspects of the claimed subject matter may be implemented. While the claimed subject matter is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1310 is only one example of a suitable operating environment and is not intended to suggest any limitation as to the scope of use or functionality of the features described herein. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 13, an exemplary environment 1310 that can be employed in connection with selectively providing advertisements to a user includes a computer 1312. The computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI). The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable ROM (EEPROM), or flash memory. Volatile memory 1320 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1312 also includes removable/nonremovable, volatile/nonvolatile computer storage media. FIG. 13 illustrates, for example a disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). For instance, a DVD-ROM drive can be employed in connection with reading video content from a DVD. To facilitate connection of the disk storage devices 1324 to the system bus 1318, a removable or non-removable interface is typically used such as interface 1326.

It is to be appreciated that FIG. 13 describes software that acts as an intermediary between users and the basic computer resources described in suitable operating environment 1310. Such software includes an operating system 1328. Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. It is to be appreciated that the subject invention can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, remote control, and the like. As described above, advertisements can be provided to a user upon receipt of user input. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312, and to output information from computer 1312 to an output device 1340. Output adapter 1342 is provided to illustrate that there are some output devices 1340 like monitors, speakers, and printers among other output devices 1340 that require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, ISDN adapters, and Ethernet cards.

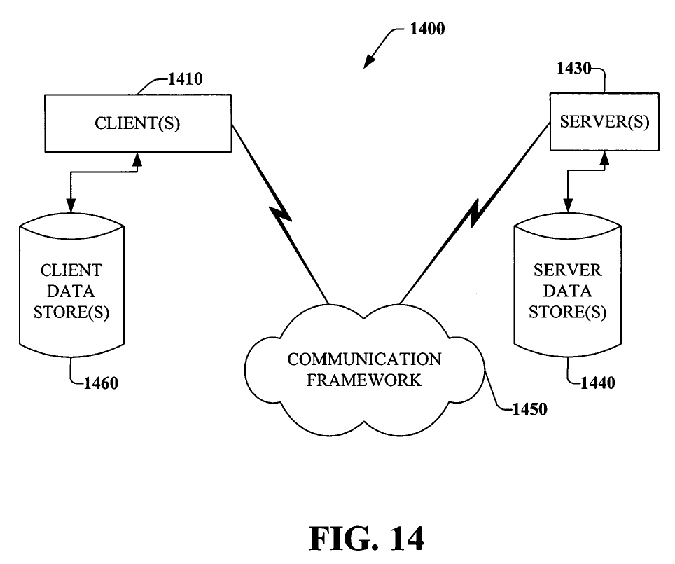

FIG. 14 is a schematic block diagram of a sample-computing environment 1400 with which the claimed subject matter can interact. The system 1400 includes one or more client(s) 1410. The client(s) 1410 can be hardware and/or software (e.g., threads, processes, computing devices). The system 1400 also includes one or more server(s) 1430. The server(s) 1430 can also be hardware and/or software (e.g., threads, processes, computing devices). The servers 1430 can house threads to perform transformations by employing the claimed subject matter, for example. One possible communication between a client 1410 and a server 1430 can be in the form of a data packet adapted to be transmitted between two or more computer processes. The system 1400 includes a communication framework 1450 that can be employed to facilitate communications between the client(s) 1410 and the server(s) 1430. The client(s) 1410 are operably connected to one or more client data store(s) 1460 that can be employed to store information local to the client(s) 1410. Similarly, the server(s) 1430 are operably connected to one or more server data store(s) 1440 that can be employed to store information local to the servers 1430. In one particular example, the client(s) 1410 can be employed to display video to a user while the server(s) can be advertisement server(s) that house advertisements associated with displayed video. For instance, the client(s) 1410 can connect to the server(s) upon playing of a video to retrieve advertising information associated with the video.

What has been described above includes examples of the claimed subject matter. It is, of course, not possible to describe every conceivable combination of components or methodologies for purposes of describing such subject matter, but one of ordinary skill in the art may recognize that many further combinations and permutations are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An advertisement display system comprising the following computer-executable components:
an analyzer component that analyzes one or more of data associated with at least a portion of a multimedia item, demographic information associated with the multimedia item, and contextual data; and
a presentation component that selectively provides at least one advertisement from a plurality of advertisements to a reviewer of the multimedia item based at least in part upon the analysis.

2. The system of claim 1, further comprising an ad server, the presentation component receives the at least one advertisement from the ad server based at least in part upon the analysis.

3. The system of claim 1, further comprising a reception component that receives user input relating to the multimedia item, the multimedia item and advertisements associated with such multimedia item are encapsulated on a computer-readable medium, the presentation component selectively retrieves the at least one advertisement from the computer-readable medium based at least in part upon the analysis and the received user input.

4. The system of claim 3, the computer-readable medium is at least one of a DVD, a CD, and a hard drive.

5. The system of claim 3, the user input received by the reception component relates to pausing the multimedia item.

6. The system of claim 3, the user input received by the reception component relates to selection of an item within the multimedia item.

7. The system of claim 1, further comprising a sensing component that senses contextual data, the presentation component selects one of a plurality of advertisements based at least in part upon the sensed contextual data.

8. The system of claim 1, further comprising a download component that downloads advertising data associated with the multimedia item.

9. The system of claim 1, the multimedia item is one of a video item, an audio item, and an audio/video item.

10. The system of claim 1, further comprising a stepping component that facilitates presentation of advertisements associated with particular scenes as a user scrolls through scenes of the multimedia item.

11. The system of claim 1, further comprising a highlighting component that highlights content within the multimedia item that is associated with at least one advertisement, the highlighted content is selectable by the reviewer.

12. The system of claim 1, a portable device comprises the analyzer component and the presentation component.

13. The system of claim 1, further comprising a collection component that at least one of reports click-through information to an advertising server, collects click-through information, and calculates click-through information associated with an advertisement.

14. The system of claim 1, further comprising a purchasing component that facilitates purchase of an advertised item presented to the reviewer.

15. A method for monetizing multimedia items comprising the following computer-executable acts:
receiving a multimedia item;
determining current position within the multimedia item; and
selectively providing an advertisement from a plurality of advertisements to a user relating to content that is associated with the determined current position.

16. The method of claim 15, further comprising:
receiving user input; and
providing the advertisement to the user based at least in part upon the user input.

17. The method of claim 15, further comprising:
connecting to an advertisement server based at least in part upon the received multimedia item; and
selecting at least one advertisement from the advertisement server.

18. The method of claim 15, further comprising:
determining contextual information associated with the multimedia item, including at least one of IP address of a device utilized to review the multimedia item, time of day, day of week, time of year, type of device utilized to review the multimedia item, and user data; and
selectively providing the advertisement to the user based at least in part upon the determined contextual information.

19. The method of claim 15, further comprising:
highlighting selectable content within the multimedia item that is associated with at least one advertisement; and
providing the at least one advertisement upon a selection of the highlighted content.

20. A multimedia item monetization system, comprising:
computer-executable means for receiving user input relating to multimedia content being reviewed by a user; and
computer-executable means for selectively providing an advertisement from a plurality of advertisements to the user based at least in part upon one or more of current position of the multimedia content at a time of receipt of the user input, demographic information associated with the user, and contextual data.
